(19) United States
(12) Patent Application Publication
(10) Pub. No.: US 2002/0094247 A1
(43) Pub. Date: Jul. 18, 2002

(54) Pipe end chamfering tool and measurement device

(76) Inventors: Donald W. Wartluft, Broken Arrow, OK (US); David E. Bentley, Catoosa, OK (US)

Correspondence Address: HEAD, JOHNSON & KACHIGIAN, 228 W 17TH PLACE, TULSA, OK, 74119, US

(21) Appl. No.: 09/759,775

(22) Filed: Jan. 12, 2001

Related U.S. Application Data
(60) Provisional application No. 60/224,044, filed on Aug. 9, 2000.

(51) Int. Cl. B23B 51/00

(52) U.S. Cl. 408/82; 408/211; 408/223; 408/227

(57) ABSTRACT

A pipe end chamfering tool for creating a bevel on the inside diameter or the outside diameter, or the inside and the outside diameter of a pipe end. The tool includes a body, one or more first projections, and at least one chamfering region at the juncture of the body and each first projection. The chamfering region is configured to cut either an inside bevel, or an outside bevel, or both an inside and an outside bevel on a pipe end. The first projection has a proximal, a middle and a terminal segment. The middle segment has a width essentially equal to the inside diameter of the pipe to be chamfered and stabilizes the pipe during chamfering. The terminal segment is semicircular and is oriented perpendicular to the plane of the proximal and middle segments. The terminal segment collects and allows removal of chips or shavings created on the inside of the pipe during chamfering. The tool includes a second projection oriented perpendicularly to the body and, in conjunction with the edge of the body opposite the second projection, provides a measuring device for an operator to mark the length of pipe which should be inserted into a stab-type pipe coupler to achieve an effective connection.

### CROSS-REFERENCE TO RELATED APPLICATIONS

Priority is claimed from provisional application U.S. Serial No. 60/224,044 filed on Aug. 9, 2000 and incorporated by reference herein.

### BACKGROUND

1. Field of Invention

The present invention is directed to a tool for chamfering pipe in order to provide an inside, an outside, or both an inside and an outside bevel on a pipe end. In particular, the present invention is directed to a pipe end chamfering tool that will chamfer a pipe end and collect the shavings or chips created during chamfering the inside bevel on the pipe end.

2. Prior Art

Plastic piping and plastic piping systems have become important in many industries. Among these industries are oil, gas and water transmission, sewer and drain transmission, fire sprinklers, and double containment piping for handling of toxic materials. The acceptance of plastic piping systems has been due to its many desirable features such as corrosion resistance, chemical resistance, low thermal conductivity, flexibility, lightweight nature, and a variety of joining methods. These joining methods may include various fittings such as stab on-couplings where no fasteners, clamps or tools are required. Two examples of such stab-on couplings are shown in assignee's U.S. Pat. Nos. 5,524,940 and 5,692,785.

At the field installation level, when the plastic pipe is cut to the desired length, the end is typically cut-off perpendicular to the axis of the pipe. The face of the pipe end is therefore flat. Before the pipe end is inserted into a fitting such as a stab on-coupling it has been found to be desirable to provide a beveled edge to the pipe end. Depending on the applications, it is desirable to have a bevel on the outside edge (to the outside diameter of the pipe) or on the inside edge (to the inside diameter of the pipe) or, in certain applications, it is desirable to have a bevel on both the outside edge and on the inside edge. These bevels allow for easier installation into socket depths and also allow the pipe to pass over O-rings or other seals without unseating the seal.

In the past, chamfering or beveling of pipe ends has been performed by shaving with a blade. One such tool is similar to a pencil sharpener having an angled blade oriented in a holder. Other examples are also seen in Muse (U.S. Pat. No. 2,838,773) and Dackow (U.S. Pat. No. 3,595,107). While these tools adequately put a bevel on the edge or on the edges, they also leave shavings or chips in the process. While the shavings from the outside diameter (OD) would normally fall away, it is possible for the inside diameter (ID) shavings to be deposited inside of the pipe, which is not desirable.

Another method to provide the desired bevels on the pipe end is to use a pipe end forming tool such as that shown in Assignee's U.S. Pat. No. 5,853,272. Such pipe forming tools take advantage of the malleability of certain plastic piping material to form a bevel without production of shavings or chips. Such pipe forming tools have certain limitations; however, they are relatively expensive to manufacture and their application is limited by the malleability of the piping material.

There is therefore a need for a pipe end chamfering tool that will bevel the inside edges of a pipe end and prevent the shavings or chips produced during beveling from being deposited on the inside of the pipe.

There is also a need for an inexpensive tool which will simultaneously chamfer both an inside and an outside bevel on a pipe end.

There is a need for an inexpensive tool that may be packaged with the fittings and disposed of after use.

Furthermore, there is a need for an inexpensive tool which will permit the operator to accurately mark the outside diameter of the pipe to indicate the length of pipe which must be inserted into the connector to produce an effective connection.

Accordingly, it is a principal object and purpose of the present invention to provide a pipe end chamfering tool that will create a bevel on the outside or on the inside or on both the inside and outside edges of a pipe end.

It is a further object and purpose of the present invention to provide a pipe end chamfering tool that will create an inside bevel on a pipe end and provide a means to remove shavings or chips created during the chamfering process from the inside of the pipe.

It is a further object and purpose of the present invention to provide a pipe end chamfering tool that may be manually operated by rotation in either direction.

It is a further object and purpose of the present invention to provide a pipe end chamfering tool that will accommodate pipes having different diameters.

It is a further object and purpose of this invention to provide a pipe end chamfering tool that will permit the operator to accurately mark the outside diameter of the pipe to indicate the length of pipe which must be inserted into a pipe connector to produce an effective connection.

### SUMMARY OF THE INVENTION

The present invention is directed to a pipe end chamfering tool which will include a body having a first projection extending from the body. In a second preferred embodiment, the body will have multiple first projections extending from the sides of the body.

Each first projection includes a proximal segment, a middle segment and a terminal segment. The middle segment of each first projection has parallel edges and has a width nearly or essentially equal to that of the inside diameter of the pipe to be chamfered. The middle segment stabilizes the tool inside the pipe.

The terminal segment of each first projection has a semicircular edge and is oriented perpendicular to the plane of the proximal and middle segments of the first projection. The terminal segment collects shavings or chips which fall inside the pipe during the chamfering process.

Each first projection will have at least one chamfering region at the juncture of the first projection and the body. Each chamfering region may be configured to chamfer the inside edge (the inside diameter of a pipe end), the outside edge (the outside diameter of a pipe end), or both the inside and outside edge of a pipe end.

The tool is operated by inserting the first projection into the terminal end of a pipe and advancing the tool until the chamfering region engages the end of the pipe. The tool is rotated while maintaining axial force against the end of the pipe. The tool may be rotated either clockwise or counterclockwise.

The tool may include a measuring device for marking the correct stab depth on the outside diameter of a length of pipe. The measuring device includes a second projection oriented perpendicular to the plane of the body. The stab depth may be marked on the outside diameter of a pipe by placing the terminal end of a pipe against and perpendicular to the second projection and marking the pipe using the edge of the body opposite of the second projection as a marking guide when inserted in a stab fitting, the pipe will be inserted up to the position marked.

The term “chamfer”, as used herein, means bevel. It is not synonymous with “form”, “deburr” or “crimp”.

The term “stab depth”, as used herein, refers to the length of pipe end which should be inserted into a pipe coupler to achieve a sealed connection.

### BRIEF DESCRIPTION OF THE DRAWINGS

FIG. 1 is a partial view of a pipe end shown in longitudinal cross-section prior to use of the present invention.

FIG. 2 is a partial view of a pipe end shown in longitudinal cross-section after application of an embodiment of the invention illustrated in FIGS. 3, 4 and 5B.

FIG. 3 is an isometric view of one embodiment of a pipe end chamfering tool constructed in accordance with the present invention.

FIG. 4 is an isometric view of one embodiment of a pipe end chamfering tool rotated from the isometric view shown in FIG. 3.

FIG. 5A is an isometric view of a pipe end chamfering tool having a chamfering region.

FIG. 5B is an enlarged view of the portion shown in FIG. 5A.

FIG. 5C is an enlarged view of an alternate chamfering region.

FIG. 5D is an enlarged view of an alternate chamfering region.

FIG. 6 is an illustration of the manner of using the present invention.

FIG. 7 is an isometric view of a second embodiment of a pipe end chamfering tool constructed in accordance with the present invention.

### DETAILED DESCRIPTION OF THE PREFERRED EMBODIMENTS

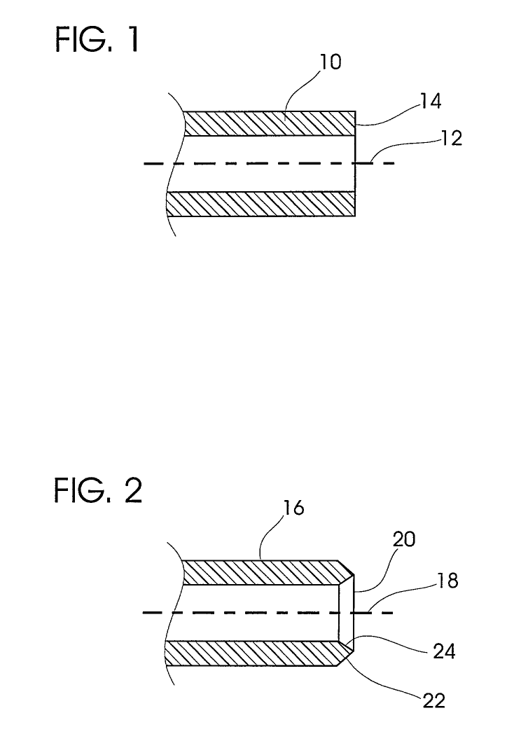

Referring to the drawings in detail, FIG. 1 shows a longitudinal cross-sectional view of a portion of pipe end which has been cut through a diameter for clarity. In the present embodiment, polyethylene pipe is shown, although the invention will work equally well with pipes made of other plastics or a metal softer than the material used to manufacture the present invention. A pipe 10 has an axis illustrated by a dashed line 12. The pipe 10, during installation, will be cut off to the desired length perpendicular to the axis 12 to form a flat face 14. In some usage applications, it has been found that it is extremely desirable to add either an inside, an outside, or both an inside and outside beveled edge to the pipe 10. For example, Assignee's stab-type coupler shown in U.S. Pat. No. 5,524,940 has both inside and outside seals that engage the pipe walls. It has been found that beveled pipe ends will more easily engage a coupler device (not shown). FIG. 2 illustrates a cross-section of a plastic pipe 16 having an axis illustrated by a dashed line 18. The end 20 of the pipe 16 has both an outside bevel 22 extending between the pipe end 20 and outside pipe surface (not shown) and an inside bevel 24 extending between the pipe end 20 and inside pipe surface (not shown). FIG. 2, thus, illustrates the pipe end 20 after usage of one embodiment of the present invention.

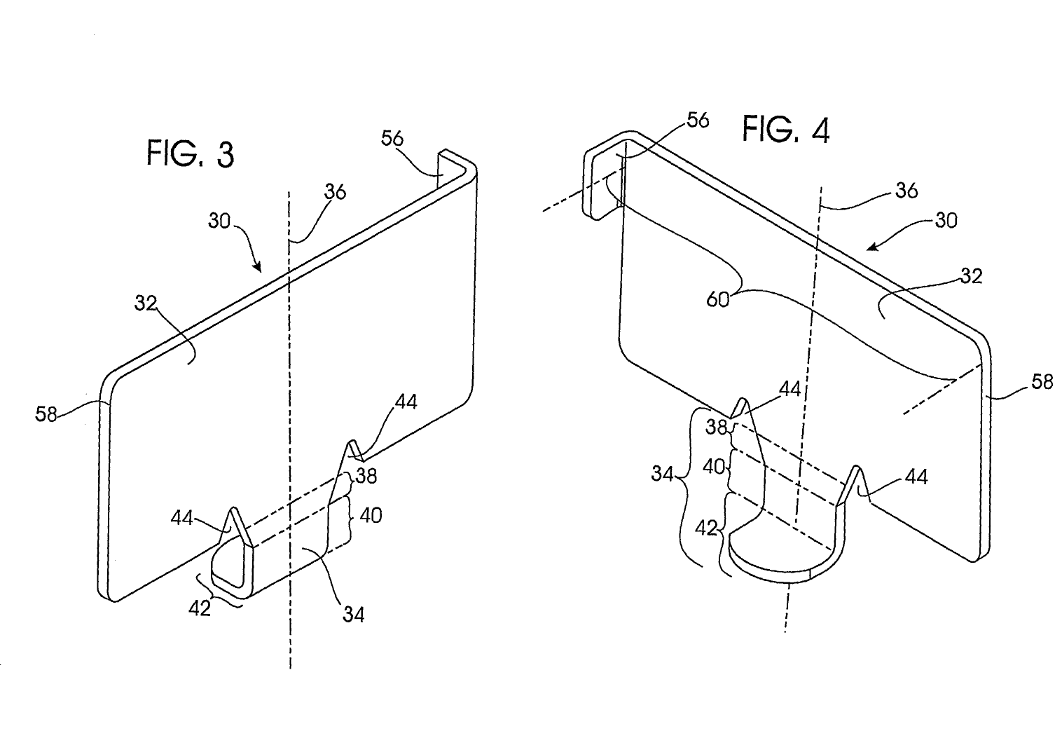

FIGS. 3 and 4 illustrate one embodiment of the present invention of a pipe chamfering tool 30 which is constructed in accordance with the present invention. The pipe chamfering tool 30 includes a body 32 which in the present embodiment is essentially flat and rectangular. The body 32 has a first projection 34 which extends from one side of the body 32 and in the same plane as the body 32. The first projection 34 has an axis illustrated by the dashed line 36. The first projection 34 has a proximal segment 38, a middle segment 40 and a terminal segment 42. The middle segment 40, which has essentially parallel sides and has a width that is essentially the same as the inside diameter of the pipe (not shown) to be chamfered, stabilizes the pipe during the chamfering process. The terminal segment 42 has a semi-circular edge and is essentially perpendicular to the plane of the body 32, the proximal segment 38 and the middle segment 40. The radius of the semi-circular edge is just slightly less than the inside radius of the pipe. The terminal segment 42 collects any shavings or chips created during the chamfering of the inside edge of the pipe end.

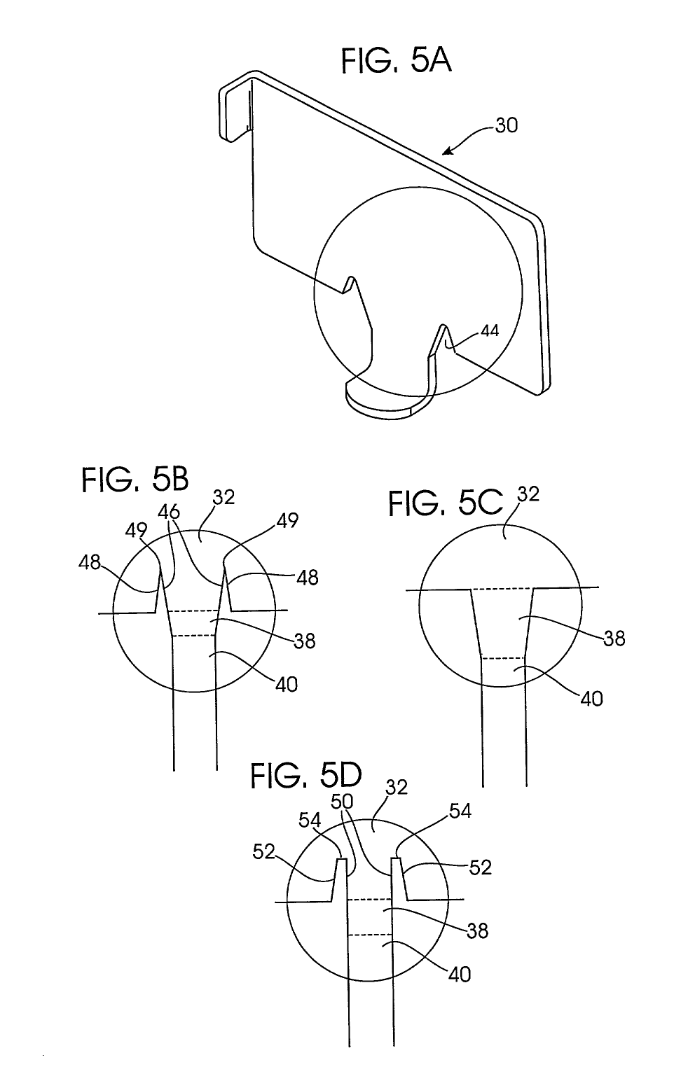

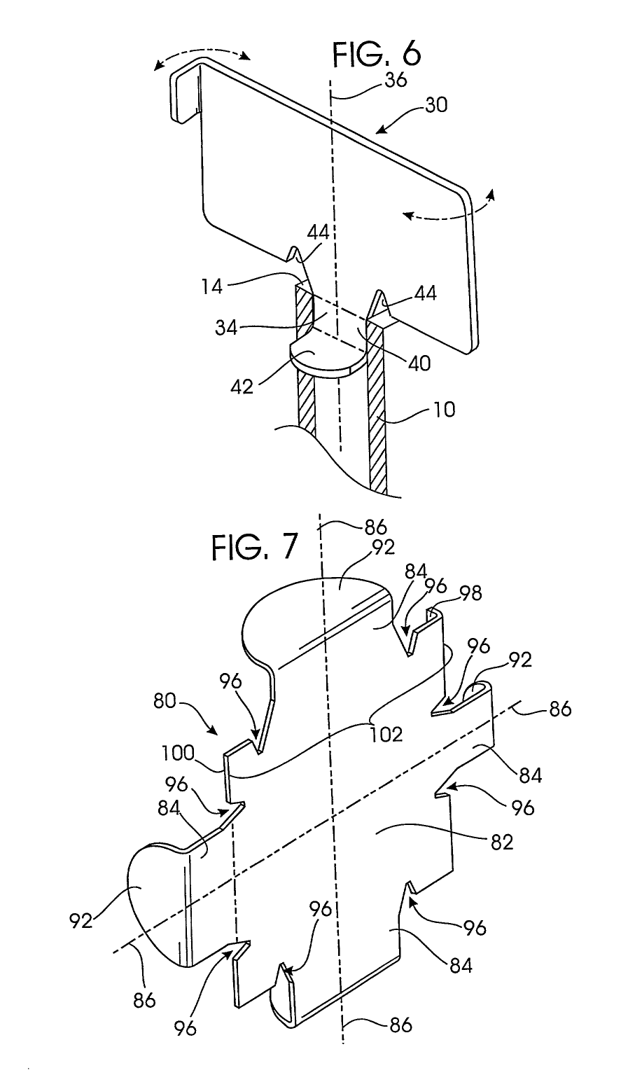

At the juncture of the body 32 and the first projection 34 is a chamfering region 44. FIGS. 5B, 5C and 5D illustrate the details of three alternative configurations of the chamfering region 44.

FIG. 5B illustrates chamfering region 44 configured to chamfer both the inside and outside diameter of a pipe end. The chamfering region 44 is essentially a V-shaped notch extending into the body 32 which has an inside edge 46 and an outside edge 48 and a base 49. Inside edge 46 is continuous with the outside edge 48 of the proximal segment 38. Inside edge 46 and outside edge 48 intersect base 49 at an angle equal to that of the bevels to be chamfered on the inside and outside diameters of the pipe end and are provided with a cutting means.

FIG. 5C illustrates chamfering region 44 configured to chamfer only the inside diameter of a pipe end. In this configuration the outside edge 48 of the proximal segment 38 intersects the body 32 at an angle equal to that of the bevel to be chamfered on the inside diameter of the pipe end and the outside edges 48 of the proximal segment 38 are provided with a cutting means.

FIG. 5D illustrates chamfering region 44 configured to chamfer only the outside diameter of a pipe end. Chamfering region 44 extends into the body 32 and is configured as a groove which has an inside edge 50, an outside edge 52 and a base 54. In this configuration, proximal segment 38 has parallel sides and is essentially the same width as the middle segment 40. The inside edges 50 of the chamfering regions 44 are parallel to each other. The base 54 is perpendicular to the inside edge 50. Outside edge 52 intersects base 54 at an angle equal to that of the bevel to be chamfered on the outside diameter of the pipe end and is provided with a cutting means.

It can it be appreciated by one skilled in the art that the chamfering region 44 illustrated in FIG. 5D could be easily modified to chamfer a bevel on the inside diameter of a pipe end by having outside edge 52 perpendicular to base 54 and by having inside edge 50 intersect base 54 at an angle equal to that of the bevel to be chamfered on the inside diameter of the pipe end and providing a cutting means on inside edge 50.

FIG. 6 illustrates the method of using the pipe end chamfering tool. First projection 34 is manually inserted into a pipe, such as a pipe 10, having a flat face 14, until the outside edges of the middle segment 40 engage the inside walls of the pipe. The pipe chamfering tool 30 will be forced axially into pipe end 20 until the chamfering region 44 engages pipe end 20. Thereafter pipe 10 will be held and tool 30 rotated by the operator around the axis 36 of the first projection 34 while at the same time maintaining the axial force on pipe 10. As the tool 30 is rotated, the pipe 10 will be stabilized by the middle segment 40 of the first projection 34 and the pipe end 20 will be chamfered by the cutting means provided in the chamfering region 44. The tool 30 may be rotated either clockwise or counterclockwise with equal results. Shavings or chips falling to the inside of pipe 10 during the chamfering process will be collected by terminal segment 42 and can be removed from the inside of the pipe when the chamfering procedure is complete.

Referring again to FIGS. 3 and 4, the body 32 of the tool 30 has a second projection 56 essentially perpendicular to the plane of the body 32. After placing a pipe end 20 against the second projection 56 with the axis of the pipe 10 perpendicular to the second projection 56, the operator will mark the outside diameter of the pipe 10 using the edge 58 as a marking guide. The distance between the second projection 56 and the marking edge 58 as illustrated by line 60 corresponds to the “stab depth” or the length of pipe which should be inserted into a stab-type connector to create an effective connection. The stab depth is determined by the particular coupler being utilized.

FIG. 7 illustrates a second embodiment of the present invention. A pipe chamfering tool 80 has a quasi-polygonal body 82 and has a plurality of first projections 84 extending from the sides of, and in the same plane as, the body 82. Each first projection 84 has an axis as illustrated by the dashed line 86. Each first projection 84 has a proximal segment 88, a middle segment 90, and a terminal segment 92. Each first projection 84 is flanked by a pair of chamfering regions 96 which can be configured as illustrated in FIGS. 5B, 5C or 5D and described above. Each first projection 84 has a terminal segment 92 which is essentially semi-circular and is oriented essentially perpendicular to the plane of body 82 and the proximal segment 88 and middle segment 90 of first projection 84. This embodiment also provides a measuring device for marking the stab depth as illustrated by line 102 by having a second projection 98 oriented essentially perpendicular to the plane of the body 82 and a marking edge 100.

As can be appreciated by one skilled in the art, the embodiment illustrated in FIG. 7 can be manufactured to provide several different configurations of pipe end chamfering tools. For example, a tool can be manufactured with three first projections in which the middle segments of all three first projections are the same width, with each first projection having a different configuration of the chamfering region. In this way, one could manufacture a tool which would chamfer the inside diameter, the outside diameter, and the inside and outside diameter of one size of pipe.

Alternatively, one could manufacture the invention such that each first projection has a different width of the middle segment and has the same configuration of the chamfering area for all first projections, thereby making a tool which would chamfer only the inside diameter of multiple sizes of pipe, a tool which would chamfer only the outside diameter of multiple sizes of pipe, or a tool which would chamfer both the inside and outside diameters of multiple sizes of pipe.

Although the embodiments illustrated in the accompanying figures are directed specifically toward a pipe chamfering tool which is manually powered, it is obvious to one skilled in the art that the embodiments illustrated in FIGS. 3 and 4 could be converted for use with a power tool, such as an electric drill or screw driver, by the addition of a third projection from the body opposite the first projection and having the same axis as the first projection, the third projection having the cylindrical or hexagonal shank configuration typical of attachments in current use with power drills and power or manual screwdrivers.

The present invention can be manufactured from metal or other essentially rigid material including plastic. The hardness of the material selected for manufacture is dependant upon the hardness of the piping material to be chamfered. Prototypes of the invention have been manufactured from metal, specifically steel, by die stamping. The cutting means which enables chamfering in the die stamped prototypes is provided by the inherent tendency of the die stamping process to bevel the edges of the side of the metal which is toward the stamping die and leave burrs on the edges of the side of the metal which is away from the die. Alternate methods of providing the cutting means required for chamfering could be utilized, such as filing, grinding or serrating.

It is further contemplated that cutting means required for chamfering could be replaceable blades. The dulled or worn blades could be removed and a new blade could be inserted so that the body of the device could be reused and only the used blades discarded. Replaceable blades would further allow different configuration of cutting means with the use of one body of the device. Replaceable blades would also allow the user of the device to customize the cutting means to the type of material to be chamfered. Replaceable blades for cutting harder material, such as metals, could slip over, snap on or otherwise attach to the cutting means region so that the device has more universal utility for different tasks requiring sharper or harder cutting means.

In summary, the present invention provides a pipe end chamfering tool comprising: a body having a first projection, the first projection extending from the body, the first projection having a proximal segment adjacent to the body, a middle segment, and a terminal segment; and at least one chamfering region at the juncture of the first projection and the body.

The present invention also provides a pipe end chamfering tool in which the body is quasi-polygonal.

The present invention provides a pipe end chamfering tool in which the first projection extends from one side and in the same plane as the body.

The present invention also provides a pipe end chamfering tool which includes two chamfering regions, one of the chamfering regions located on either side of the first projection at the juncture of the first projection and the body.

The present invention provides a pipe end chamfering tool in which the middle segment of the first projection has essentially parallel sides and has a width essentially equal to that of the inside diameter of the pipe to be chamfered.

The present invention provides a pipe end chamfering tool in which the terminal segment of the first projection is essentially semi-circular and the terminal segment is oriented in a plane essentially perpendicular to the plane of the body and the first projection.

The present invention provides a pipe end chamfering tool in which the chamfering region is an essentially V-shaped notch, the notch extending into the body, the notch having an inside edge, an outside edge and a base, the inside edge being contiguous with the outside edge of the proximal segment of the first projection, the inside edge and outside edge intersecting the base at an angle essentially equal to that of the desired bevel to be chamfered on the end of a pipe, and a cutting means is provided on both the inside edge and outside edge of the notch.

The present invention also provides a pipe end chamfering tool in which the chamfering region is a groove, the groove extending into the body, the groove having an inside edge, a base, and an outside edge, the inside edge of the groove being contiguous with the outside edge of the proximal segment of the first projection.

The present invention provides a pipe end chamfering tool in which the chamfering region is a groove extending into the body where the sides of the proximal segment are essentially parallel to each other, in which the angle at which the inside edge of the groove intersects the base is essentially 90° and the angle at which the outside edge of the groove intersects the base is essentially equal to that of the angle of the bevel to be chamfered on the outside diameter of the end of a pipe, in which a cutting means is provided on the outside edge of the groove.

The present invention provides a pipe end chamfering tool in which the chamfering region is a groove extending into the body where the angle at which the outside edge of the groove intersects the base is essentially 90° and the angle at which the inside edge of the groove intersects the base is essentially equal to that of the angle of the bevel to be chamfered on the inside diameter of the end of a pipe, and a cutting means is provided on the inside edge of the groove.

Also included in the present invention is a pipe end chamfering tool in which the proximal segment of the first projection intersects the body at an angle essentially equal to the angle of the bevel to be chamfered on the inside diameter of a pipe end and a cutting means is provided on the outside edge of the proximal segment.

The present invention provides a pipe end chamfering tool in which the body has a second projection, the second projection extending from one side of the body and in a plane essentially perpendicular to the plane of the body.

The present invention provides a pipe end chamfering tool comprising: a body having multiple first projections, each of the first projections extending from the body, the first projection having a proximal segment adjacent to the body, a middle segment, and a terminal segment; and a plurality of chamfering regions, one of the chamfering regions located at the juncture of each the first projections and the body.

The present invention provides a pipe end chamfering tool with a plurality of first projections in which the body is quasi-polygonal.

The present invention provides a pipe end chamfering tool with a plurality of first projections in which each of the first projections extends from the body in the same plane as the body.

The present invention provides a pipe end chamfering tool with a plurality of first projections in which there are two chamfering regions associated with each first projection, one of the chamfering regions located on either side of the juncture of each the first projection and the body.

The present invention provides a pipe end chamfering tool with a plurality of first projections in which the middle segment of each first projection has essentially parallel sides and has a width essentially equal to that of the inside diameter of the pipe to be chamfered.

The present invention provides a pipe end chamfering tool with a plurality of first projections in which the terminal segment of each first projection is essentially semi-circular and the terminal segment is oriented in a plane essentially 90° to the plane of the body and the first projection.

The present invention also provides a pipe end chamfering tool with a plurality of first projections in which the chamfering region is an essentially V-shaped notch, the notch extending into the body, the notch having an inside edge, a base and an outside edge, the inside edge being contiguous with the outside edge of the proximal segment of the first projection, the inside edge and outside edge intersecting the base at an angle equal to that of the desired bevel to be chamfered on the end of a pipe, and a cutting means is provided on both the inside edge and outside edge of the notch.

The present invention provides a pipe end chamfering tool with a plurality of first projections in which the chamfering region is a groove, the groove extending into the body, the groove having an inside edge, a base, and an outside edge, the inside edge of the groove being contiguous with the outside edge of the proximal segment of the first projection.

The present invention also provides a pipe end chamfering tool with a plurality of first projections in which the chamfering region is a groove extending into the body, in which the sides of the proximal segment of the first projection are essentially parallel to each other, the angle at which the inside edge of the groove intersects the base is essentially 90° and the angle at which the outside edge of the groove intersects the base is essentially equal to that of the angle of the bevel to be chamfered on the outside diameter of the end of a pipe, and a cutting means is provided on the outside edge of the groove.

The present invention provides a pipe end chamfering tool with a plurality of first projections and the chamfering region is a groove extending into the body in which the angle at which the outside edge of the groove intersects the base is essentially 90° and the angle at which the inside edge of the groove intersects the base is essentially equal to that of the angle of the bevel to be chamfered on the inside diameter of the end of a pipe, and a cutting means is provided on the inside edge of the groove.

The present invention provides a pipe end chamfering tool with a plurality of first projections in which the proximal segment of the first projection intersects the body at an angle equal to the angle of the bevel to be chamfered on the inside diameter of a pipe end, and a cutting means is provided on the outside edge of the proximal segment.

The present invention also provides a pipe end chamfering tool with a plurality of first projections, in which the body has a second projection, the second projection extending from one side of the body and in a plane essentially perpendicular to the plane of the body.

In addition, the present invention provides a method to chamfer a pipe end, which method comprises: inserting a pipe end chamfering tool having at least one projection, a portion of the projection which is of a width equal to the inside diameter of the pipe, and a chamfering region on at least one side of the projection, into a pipe having an end face perpendicular to its axis; manually forcing the tool axially into the pipe end to engage the chamfering region; and rotating the tool while maintaining the axial force to cut bevels on the pipe end.

The present invention also provides a method to chamfer a pipe end using a pipe end chamfering tool in which the rotating of the tool may be either clockwise or counterclockwise.

The present invention also provides a method to chamfer a pipe end using a pipe end chamfering tool in which the rotating of the tool may be accomplished by either manual or mechanical means.

Whereas, the present invention has been described in relation to the drawings attached hereto, it should be understood that other and further modifications, apart from those shown or suggested herein, may be made within the spirit and scope of this invention.

What is claimed is:

1. A pipe end chamfering tool comprising:
a) a body having a first projection, said first projection extending from said body, said first projection having a proximal segment adjacent to said body, a middle segment, and a terminal segment; and
b) at least one chamfering region at the juncture of said first projection and said body.

2. The pipe end chamfering tool as set forth in claim 1 wherein said body is quasi-polygonal.

3. The pipe end chamfering tool as set forth in claim 1 wherein said first projection extends from the same plane as said body.

4. The pipe end chamfering tool as set forth in claim 1 wherein there are two said chamfering regions, said chamfering regions located on each side of said first projection at the juncture of said first projection and said body.

5. The pipe end chamfering tool as set forth in claim 1 wherein said middle segment of said first projection has parallel sides and has a width essentially equal to that of the inside diameter of the pipe to be chamfered.

6. The pipe end chamfering tool as set forth in claim 1 wherein said terminal segment of said first projection is semi-circular, wherein said terminal segment is oriented in a plane perpendicular to the plane of said body and said first projection.

7. The pipe end chamfering tool as set forth in claim 1 wherein said chamfering region is a V-shaped notch extending into said body, said notch having an inside edge, an outside edge and a base, said inside edge being contiguous with the outside edge of the proximal segment of the first projection, said inside edge and outside edge intersecting said base at an angle essentially equal to that of the desired bevel to be chamfered on the end of a pipe, wherein a cutting means is provided on both the inside edge and outside edge of said notch.

8. The pipe end chamfering tool as set forth in claim 1 wherein said chamfering region is a groove, said groove extending into said body, said groove having an inside edge, a base, and an outside edge, said inside edge of the groove being contiguous with the outside edge of the proximal segment of the first projection.

9. The pipe end chamfering tool as set forth in claim 8 wherein the sides of said proximal segment are essentially parallel to each other, wherein the angle at which said inside edge of said groove intersects said base is essentially 90° and the angle at which said outside edge of said groove intersects said base is essentially equal to that of the angle of the bevel to be chamfered on the outside diameter of the end of a pipe, wherein a cutting means is provided on the outside edge of said groove.

10. The pipe end chamfering tool as set forth in claim 8 wherein the angle at which said outside edge of said groove intersects said base is essentially 90° and the angle at which said inside edge of said groove intersects said base is essentially equal to that of the angle of the bevel to be chamfered on the inside diameter of the end of a pipe, wherein a cutting means is provided on the inside edge of said groove.

11. The pipe end chamfering tool as set forth in claim 1 wherein said proximal segment of said first projection intersects said body at an angle equal to the angle of the bevel to be chamfered on the inside diameter of a pipe end, wherein a cutting means is provided on the outside edge of said proximal segment.

12. The pipe end chamfering tool as set forth in claim 1 wherein said body has a second projection, said second projection extending from one side of said body and in a plane essentially perpendicular to the plane of said body.

13. A pipe end chamfering tool comprising:
a body having multiple first projections, each of said first projections extending from said body, each said first projection having a proximal segment adjacent to said body, a middle segment, and a terminal segment; and
a plurality of chamfering regions, one of said chamfering regions located at the juncture of each said first projection and said body.

14. The pipe end chamfering tool as set forth in claim 13 wherein said body is quasi-polygonal.

15. The pipe end chamfering tool as set forth in claim 13 wherein each of said first projections extends from said body in the same plane as said body.

16. The pipe end chamfering tool as set forth in claim 13 wherein there are two of said chamfering regions, one of said chamfering regions located on either side of the juncture of each said first projection and said body.

17. The pipe end chamfering tool as set forth in claim 13 wherein said middle segment of said first projection has essentially parallel sides and has a width essentially equal to that of the inside diameter of the pipe to be chamfered.

18. The pipe end chamfering tool as set forth in claim 13 wherein said terminal segment of said first projection is essentially semi-circular and said terminal segment is oriented in a plane essentially 90° to the plane of said body and said first projection.

19. The pipe end chamfering tool as set forth in claim 13 wherein said chamfering region is an essentially V-shaped notch, said notch extending into said body, said notch having an inside edge and an outside edge, said inside edge being contiguous with the outside edge of the proximal segment of the first projection, said inside edge and outside edge intersecting at an angle equal to that of the desired bevel to be chamfered on the end of a pipe, wherein a cutting means is provided on both the inside edge and outside edge of said notch.

20. The pipe end chamfering tool as set forth in claim 13 wherein said chamfering region is a groove, said groove extending into said body, said groove having an inside edge, a base, and an outside edge, said inside edge of the groove being contiguous with the outside edge of the proximal segment of the first projection.

21. The pipe end chamfering tool as set forth in claim 20 wherein the sides of said proximal segment are essentially parallel to each other, wherein the angle at which said inside edge of said groove intersects said base is essentially 90° and the angle at which said outside edge of said groove intersects said base is essentially equal to that of the angle of the bevel to be chamfered on the outside diameter of the end of a pipe, wherein a cutting means is provided on the outside edge of said groove.

22. The pipe end chamfering tool as set forth in claim 20 wherein the angle at which said outside edge of said groove intersects said base is essentially 90° and the angle at which said inside edge of said groove intersects said base is essentially equal to that of the angle of the bevel to be chamfered on the inside diameter of the end of a pipe, wherein a cutting means is provided on the inside edge of said groove.

23. The pipe end chamfering tool as set forth in claim 13 wherein said proximal segment of said first projection intersects said body at an angle equal to the angle of the bevel to be chamfered on the inside diameter of a pipe end, wherein a cutting means is provided on the outside edge of said proximal segment.

24. The pipe end chamfering tool as set forth in claim 13, wherein said body has a second projection, said second projection extending from one side of said body and in a plane essentially perpendicular to the plane of said body.

25. A method to chamfer a pipe end, which method comprises:
inserting a tool having a projection, a portion of said projection which is of a width equal to the inside diameter of the pipe, and a chamfering region on at least one side of said projection, into a pipe having an end face perpendicular to its axis;
manually forcing said tool axially into said pipe end to engage said chamfering region; and
rotating said tool while maintaining said axial force to cut bevels on said pipe end.

26. A method to chamfer a pipe end as set forth in claim 25 wherein said rotating of said tool may be either clockwise or counterclockwise.

27. A method to chamfer a pipe end as set forth in claim 25 wherein said rotating of said tool may be accomplished by either manual or mechanical means.
